(19) United States
(12) Patent Application Publication
(10) Pub. No.: US 2025/0385788 A1
(43) Pub. Date: Dec. 18, 2025

(54) INTEGRATED CIRCUIT FOR GENEREATING KEY ENCRYPTING KEY AND OPERATING METHOD THEREOF

(71) Applicant: SAMSUNG ELECTRONICS CO., LTD., Suwon-si (KR)

(72) Inventor: Heedong SHIN, Suwon-si (KR)

(73) Assignee: SAMSUNG ELECTRONICS CO., LTD., Suwon-si (KR)

(21) Appl. No.: 18/970,220

(22) Filed: Dec. 5, 2024

(30) Foreign Application Priority Data
Jun. 18, 2024 (KR) 10-2024-0078732

(51) Int. Cl. H04L 9/08; G06F 7/58

(52) U.S. Cl. CPC H04L 9/0869; G06F 7/588

(57) ABSTRACT

An operating method of an integrated circuit according to the present disclosure includes generating a key encryption key (KEK) using a random number generator; generating log data corresponding to the KEK using a log generator, and storing the KEK and the log data in a one-time programmable (OTP) memory, where the KEK is used to encrypt a master key of the integrated circuit for a cryptographic operation, and where the random number generator and the log generator are comprised in the integrated circuit.

### CROSS-REFERENCE TO RELATED APPLICATION(S)

This application claims benefit of priority to Korean Patent Application No. 10-2024-0078732 filed on Jun. 18, 2024 in the Korean Intellectual Property Office, the disclosure of which is incorporated herein by reference in its entirety.

### BACKGROUND

The present application relates to an integrated circuit for generating a key encryption key (KEK) and an operating method thereof.

In general, a semiconductor device capable of executing security software including a security application needs to store a key therein to permanently program the key used by the security software. For example, in a process of manufacturing a chip or chipset to be mounted on a semiconductor device, a value of the key may be fused into a one-time programmable (OTP) memory included as a component of the semiconductor device.

However, there is a need for a more secure integrated circuit for generating a KEK.

### SUMMARY

An aspect of the present disclosure is to provide an integrated circuit increasing a security level and an operating method thereof.

An aspect of the present disclosure is to provide an integrated circuit generating a key encryption key and an operating method thereof.

According to an aspect of the present disclosure, a method of operating an integrated circuit is provided. The method may be executed by at least one processor and the method includes generating a key encryption key (KEK) using a random number generator; generating log data corresponding to the KEK using a log generator; and storing the KEK and the log data in a one-time programmable (OTP) memory, wherein the KEK is used to encrypt a master key of the integrated circuit for a cryptographic operation, and wherein the random number generator and the log generator are comprised in the integrated circuit.

According to an aspect of the present disclosure, an integrated circuit is provided. The integrated circuit may include a one-time programmable (OTP) memory; a random number generator configured to generate random data corresponding to a key encryption key (KEK); a key manager configured to generate log data for the KEK; and an OTP controller configured to fuse the KEK and the log data to the OTP memory, wherein the KEK is used to encrypt a master key of the integrated circuit for a cryptographic operation.

According to an aspect of the present disclosure, a method of operating an integrated circuit is provided. The method may include receiving a key verification request from an external key verifier; reading a KEK and log data corresponding to the KEK from a one-time programmable (OTP) memory in response to the key verification request; and outputting the KEK and the log data to the external key verifier, wherein the KEK is used to encrypt a master key of the integrated circuit for a cryptographic operation.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a diagram illustrating an electronic device according to an embodiment of the present disclosure.

FIG. 2 is a diagram illustrating a schematic of a security chip according to an embodiment of the present disclosure.

FIG. 3 is a diagram illustrating a schematic of an integrated circuit according to an embodiment of the present disclosure.

FIG. 4 is a flowchart illustrating a process of storing a key encryption key (KEK) of an integrated circuit according to an embodiment of the present disclosure.

FIG. 5 is a diagram illustrating a process of performing verification of a key encryption key (KEK) inside a System-On-Chip (SoC) according to an embodiment of the present disclosure.

FIG. 6 is a diagram illustrating the SoC according to an embodiment of the present disclosure.

FIG. 7 is a diagram illustrating a processor according to an embodiment of the present disclosure.

### DETAILED DESCRIPTION

Hereinafter, example embodiments of the present disclosure will be described with reference to the accompanying drawings.

An integrated circuit and an operating method thereof according to embodiments of the present disclosure may directly fuse a key generated in a random number generator into a one-time programmable (OTP) memory without intervention of an external device (for example, a central processing unit (CPU)). For example, a key encryption key (also sometimes referred to as KEK) may be generated in the random number generator, and the generated key encryption key may be injected into the OTP memory. Here, the key encryption key may be used to generate a master key. Therefore, the external device may not see the generated key encryption key. The integrated circuit of the present disclosure may increase a security level by making the generated random data (or key encryption key) unreadable, except by security hardware. A general integrated circuit externally generates a key encryption key and injects it into an OTP memory. On the other hand, the integrated circuit of the present disclosure may generate random data inside a chip and directly inject it into the OTP memory, thereby increasing the security level. The integrated circuit according to the embodiment of the present disclosure may provide the highest security level because a key itself generated inside the chip may not be read by an external CPU.

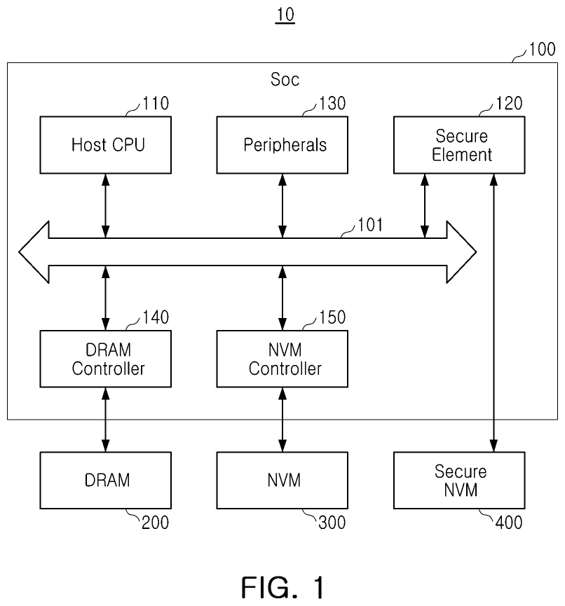

FIG. 1 is a diagram exemplarily illustrating an electronic device 10 according to an embodiment of the present disclosure. Referring to FIG. 1, the electronic device 10 may include a system on chip 100 (also referred to as SoC 100), a volatile memory device (DRAM) 200, a nonvolatile memory device (NVM) 300, and a security nonvolatile memory device (security NVM) 400.

The electronic device 10 may be any one of a smart phone, a tablet personal computer (PC), a smart TV, a mobile phone, a personal digital assistant (PDA), a laptop, a media player, a micro server, global positioning system (GPS) device, an e-book terminal, a digital broadcasting terminal, a navigation, a kiosk, an MP3 player, a digital camera, a home appliance and other mobile/non-mobile computing device. In addition, the electronic device 10 may be a wearable device such as a watch, glasses, a hair band and a ring equipped with a data processing function. In addition, the electronic device 10 may include all kinds of electronic devices operating based on an operating system (OS) using a processor.

The system on chip 100 may be implemented to control the overall operation of the electronic device 10. For example, the system on chip 100 may control at least one other component included in the electronic device 10. The system on chip 100 may drive an OS and an application program, and perform various operations or data processing. The system on chip 100 may include a dedicated processor (e.g., an embedded processor) for performing specific operations or a general-purpose processor that may perform operations by executing one or more software programs stored in a memory device. For example, the system on chip 100 may be implemented as a central processing unit (CPU), a microprocessor, a graphics processing unit (GPU), a data processing unit (DPU), a neural network processing unit (NPU) or a communication processor (CP). The system on chip 100 of the present disclosure may include a region for performing general operations and a region for performing operations related to processing of data related to security.

The system on chip 100 may include a system on chip interconnection 101, a host CPU 110, a secure element 120, peripherals 130, a DRAM controller 140 and an NVM controller 150. The secure element 120 may be defined as a secure chip.

The system on chip interconnection 101 may connect devices included in the system on chip 100. The system on chip interconnection 101 may be used as a data transmission path between the host CPU 110, the secure element 120, the peripherals 130, the DRAM controller 140 and the NVM controller 150.

The host CPU 110 may be implemented to control overall operations of the system on chip 100. The host CPU 110 may control operations of other devices included in the electronic device 10 by controlling operations of the system on chip 100. For example, the host CPU 110 may be an application processor (AP).

The secure element 120 may be implemented to perform operations related to a security of the system on chip 100. The secure element 120 may install and run a security application. In addition, the secure element 120 may store security data. The secure element 120 may include hardware, software, interfaces and protocols that enable execution of applications for secure storage and payment, authentication or other various services. In addition, the secure element 120 may be implemented to generate random data and store it in the OTP memory. That is, the secure element 120 may internally generate a key encryption key (KEK) and store the generated KEK in the OTP memory. Here, the KEK may be used to generate a master key. For example, the KEK may be used to encrypt the master key (private key or pre-shared key). The secure element 120 may perform a cryptographic operation based on the master key.

The peripherals 130 may include various devices for driving the system on chip 100.

The DRAM controller 140 may be implemented to control the DRAM 200. The DRAM controller 140 may manage data transmission between the devices included in the system on chip 100 and the DRAM 200.

The NVM controller 150 may be implemented to control the NVM device 300. The NVM controller 150 may control a read operation, a write operation, etc. of the NVM 300 based on commands received from the devices included in the system on chip 100.

As illustrated in FIG. 1, the DRAM 200 and the NVM 300 may be located outside the system on chip 100, due to the limited area of the system on chip 100, and perform operations such as storing data.

The secure NVM device 400 may be directly connected to the secure element 120 of the system on chip 100. The secure NVM device 400 may be directly connected to the secure element 120, and may store security data used for operations of the secure element 120. In embodiments, the secure NVM device 400 may not be connected to other devices of the system on chip 100 except for the secure element 120.

The system on chip 100 according to an embodiment of the present disclosure may have a secure element 120 configured to internally generate and store the KEK, thereby minimizing external exposure of the KEK and increasing a security level.

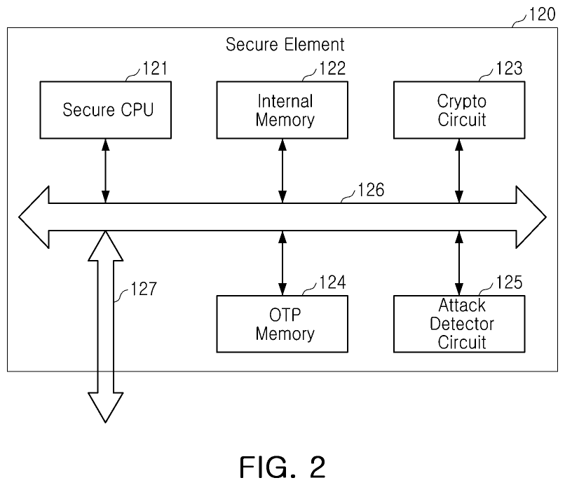

FIG. 2 is a diagram exemplarily illustrating the secure element 120 according to an embodiment of the present disclosure. Referring to FIG. 2, the secure element 120 according to an embodiment of the present disclosure may include a secure CPU 121, an internal memory 122, a crypto circuit 123, an OTP memory 124, an attack detector circuit 125, an internal bus 126 and an external bus 127.

The secure CPU 121 may be implemented to control overall operations of the secure element 120. The secure CPU 121 may perform a response operation to a security attack to maintain a security of the secure element 120.

In addition, the secure CPU 121 may generate the KEK and store the generated key KEK in the OTP memory 124. The secure CPU 121 may generate encrypted data by encrypting data through the KEK. The KEK may generate an encryption key based on an encryption key generated by the crypto circuit 123.

In addition, the secure CPU 121 may manage an access key. The security CPU 121 may provide an access key to the internal bus 126 to control an access right of one of the devices included in the secure element 120 to other device included in the secure chip 120 through the internal bus 126.

The internal memory 122 may be implemented to store the encrypted data. The internal memory 122 may include a scrambling circuit. The internal memory 122 may perform an address scrambling operation using the scrambling circuit to set an address where the encrypted data is to be stored. In addition, the internal memory 122 may search for an address where the encrypted data is stored using the scrambling circuit.

The crypto circuit 123 may perform various operations in response to a security attack. For example, the crypto circuit 123 may perform operations such as an error detection operation against a fault injection attack (FIA), data masking, key masking, and operating current/timing randomization in response to a side channel attack (SCA). In addition, the crypto circuit 123 may generate an encryption key used for encrypting general data. The crypto circuit 123 may include a random number generator and an encryption key management circuit. The random number generator may generate a random number used for generating the encryption key. The random number generated by a random number generator may be injected into another device within the secure chip 120 and used for security operations. The encryption key management circuit may generate the encryption key based on the random number generated by the random number generator. The encryption key management circuit may generate the encryption key using any one of encryption algorithms such as an Advanced Encryption Standard (AES), Data Encryption Standard (DES), Triple DES, SEED, HIGHT, ARIA, LEA, etc.

The OTP memory 124 may be implemented to store at least a portion of the KEK and the encryption key, and a unique identifier (UI) used within the secure chip 120. The OTP memory 124 may store at least a portion of the encryption key and the UID in an encrypted form. In an embodiment, the OTP memory 124 may store a log for verifying the KEK. Here, the log may be a hash value of the KEK. In an embodiment, when generating the KEK, the secure CPU 121 may generate a hash value of the KEK.

The attack detector circuit 125 may be implemented to detect whether an external attack on the encrypted data has occurred. The attack detector circuit 125 may detect a laser attack, a glitch attack, a voltage attack, a temperature attack, etc. from the outside. The attack detector circuit 125 may include various types of sensors for detecting such attacks. For example, the attack detector circuit 125 may include a reference voltage generator, a temperature detector, a voltage detector and a voltage regulator. The reference voltage generator may generate a reference voltage. The reference voltage generator may generate a constant voltage regardless of an external environment and supply it to other devices in the attack detector circuit 125. The temperature detector may detect an abnormal temperature based on the reference voltage. The temperature detector may detect an abnormal temperature by determining whether a voltage corresponding to a temperature detected by the temperature sensor is within a normal temperature range calculated based on the reference voltage. When detecting an abnormal temperature, the temperature detector may output an alarm indicating an abnormality to the host CPU 110. The voltage detector may detect an abnormality in an external supply voltage based on the reference voltage. In an embodiment of the present disclosure, the voltage detector may detect the abnormality in the external supply voltage by determining whether the external supply voltage detected by the voltage sensor is within a normal voltage range calculated based on the reference voltage. In addition, the voltage detector may detect the abnormality in the external supply voltage by detecting whether a glitch occurs in the external supply voltage detected by the voltage sensor. If the voltage detector detects the abnormality in the external supply voltage, it may output an alarm indicating the abnormality to the host CPU 110. The voltage regulator may generate an adjustment voltage used for an operation of the security chip 120 based on the reference voltage. Since the adjustment voltage is generated based on the reference voltage having a constant magnitude regardless of an external environment, it may have a constant magnitude regardless of the external environment. Therefore, the adjustment voltage may be used for an operation of the secure chip 120 requiring a normal operation even when attacked through changes in the external environment. In an embodiment of the present disclosure, the voltage regulator may be a low-dropout (LDO) regulator.

The internal bus 126 may be used as a data transmission path between the devices included in the secure chip 120. The internal bus 126 may transmit the encrypted data within the secure chip 120 using an error detection tag. In addition, the internal bus 126 may include a bus permission switch, a plurality of tag generators, an interconnection and a plurality of tag checkers. The bus permission switch may select a target to which the encrypted data is to be transmitted within the secure chip 120 based on an access key. The plurality of tag generators may generate the error detection tag based on a type of the encrypted data, and attach the error detection tag to the encrypted data. The interconnection may transmit the encrypted data with the error detection tag attached thereto. The plurality of tag checkers may determine whether the encrypted data with the error detection tag attached is abnormal. If it is determined that no abnormality has occurred in the encrypted data with the error detection tag attached, the plurality of tag checkers may transmit the encrypted data to the transmission target device. If it is determined that an abnormality has occurred in the encrypted data with the error detection tag attached, the plurality of tag checkers may output an alarm indicating the abnormality to the host CPU 110.

The external bus 127 may be used as a data transmission path between the devices included in the secure element 120 and other devices (e.g., the host CPU 110, the peripherals 130, etc.) inside the system on chip 100 including the secure element 120. The external bus 127 may transmit the encrypted data generated inside the secure element 120 to the outside of the secure element 120. In addition, the external bus 127 may transmit the encrypted data generated outside the secure element 120 to the inside of the secure element 120. In addition, the external bus 127 may detect whether the data transmitted from outside the secure element 120 is rolled back. The external bus 127 may detect whether the data is rolled back by checking a timestamp transmitted together with the data.

Although not illustrated in FIG. 2, the secure element 120 may further include an oscillator. The oscillator may supply an independent system clock inside the secure element 120. Accordingly, a security operation inside the secure element 120 may be performed independently from the outside of the secure element 120.

Generally, a security of a KEK required to encrypt and store all keys in a system on chip is very important. In a general processor, the KEK is externally generated and injected, or a key in an external DRAM is stored in an OTP memory after self-generation. The highest level of security may be maintained when nobody can read such a random number key during a generation and storage process. Therefore, it is necessary to proceed with this process without software intervention.

An integrated circuit according to an embodiment of the present disclosure may transmit a generated KEK in a buffer of a random number generator to an OTP controller without external intervention, and may perform fusing in correspondence to the KEK in an OTP memory under a control of the OTP controller. In addition, the integrated circuit of the present disclosure may store a log data using a corresponding key in the OTP memory before fusing an e-fuse, and then check for tampering of the KEK by using the log data.

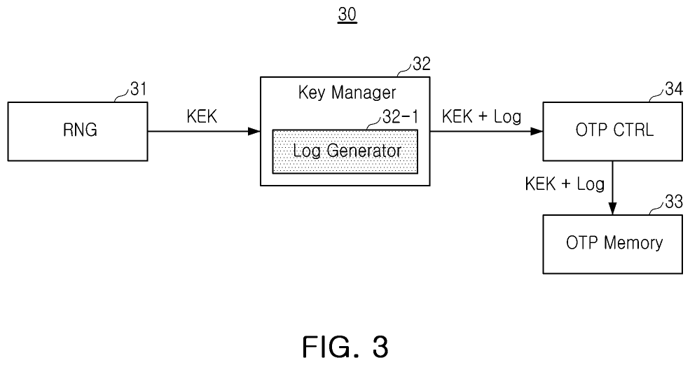

FIG. 3 is a diagram exemplarily illustrating an integrated circuit 30 according to an embodiment of the present disclosure. Referring to FIG. 3, the integrated circuit 30 may include a random number generator (RNG) 31, a key manager 32, an OTP memory 33 and an OTP controller 34.

The random number generator 31 may be implemented to generate random number data (e.g., a KEK). The random number generator 31 may be implemented as a true random number generator or a pseudo-random number generator.

The key manager 32 may store the random number data, i.e., the KEK, generated by the random number generator 31 in an internal buffer. The key manager 32 may generate log data corresponding to the KEK. The key manager 32 may include a log generator 32-1 configured to generate the log data. Here, the log generator 32-1 may be a hash logic configured to perform a hash algorithm. In an embodiment, the key manager may be implemented in hardware, software or firmware within the integrated circuit 30.

The OTP memory 33 may include a plurality of banks having a plurality of memory cells connected to word lines and bit lines. Here, each of the plurality of memory cells may store data. In addition, the OTP memory 33 may store the KEK and its log data (Log).

The OTP controller 34 may be implemented to receive the KEK and its log data (Log) from the key manager 32, and control fusing of the OTP memory 33 to store the KEK and its log data (Log) in the OTP memory 33.

In addition, the OTP controller 34 may further include a key register and a key protection control logic, although not shown. The key register may load a key stored in the OTP memory 33 and provide it to a security software. The key protection control logic may perform at least one operation on a value stored in a key protection setting region of the OTP memory 33, and determine whether to load the key stored in the OTP memory 33 into the key register based on the result of the operation.

The integrated circuit 30 according to the embodiment of the present disclosure may significantly improve a security level by performing management of a unique random OTP key. Therefore, the integrated circuit 30 of the present disclosure may secure high security using the key manager 32.

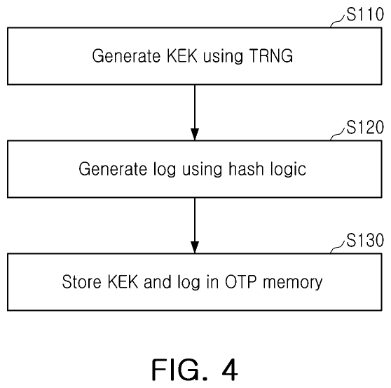

FIG. 4 is a flowchart exemplarily illustrating an operation of storing a key encryption key (KEK) of an integrated circuit according to an embodiment of the present disclosure. Referring to FIGS. 3 and 4, the KEK of the integrated circuit 30 may be stored as follows.

The integrated circuit 30 may generate random data corresponding to the KEK using the random number generator 31 (operation S110). The integrated circuit 30 may generate the log data by hashing the KEK using a hash logic (operation S120). The integrated circuit 30 may then store the KEK and its log data in the OTP memory 33 by fusing them (operation S130).

In an embodiment, the random number generator (e.g., RNG 31) may include a true random number generator. In an embodiment, the log generator (e.g., log generator 32-1) may include the hash logic. In an embodiment, a hash value for the key encryption key may be calculated by the hash logic. Here, the hash value may be log data. In an embodiment, by performing fusing for an e-fuse, the KEK and the log data may be stored in the OTP memory (e.g., OTP memory 33). In an embodiment, a key verification request may be received from an external device. In an embodiment, in response to the key verification request, the KEK and the log data may be read from the OTP memory, and the KEK and the log data, read from the OTP memory, may be output to the external device. In an embodiment, an authentication operation may be performed with the external device before receiving the key verification request.

Meanwhile, the integrated circuit and the operating method thereof according to an embodiment of the present disclosure may perform verification of the KEK stored inside the integrated circuit.

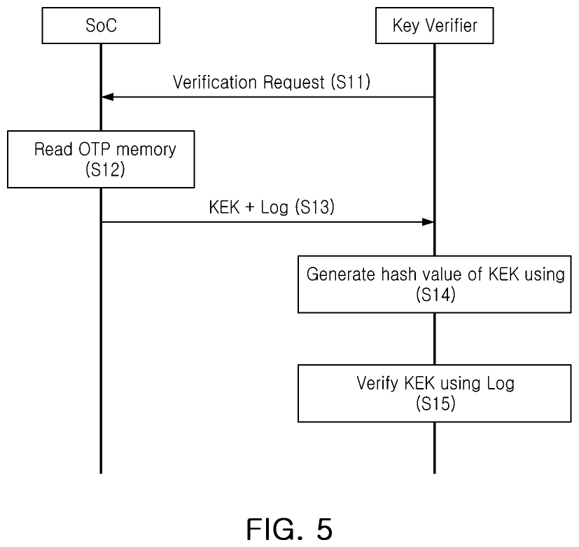

FIG. 5 is a workflow diagram exemplarily illustrating an operation of performing verification of a key encryption key (KEK) inside a system on chip (SoC) according to an embodiment of the present disclosure. Referring to FIG. 5, a key verifier may request verification of the KEK by the SoC (operation S11). In an embodiment, device authentication may be performed between the key verifier and the SoC before this verification request. The SoC may receive the verification request from the key verifier and read the KEK and the corresponding log data stored in the internal OTP memory (operation S12). The SoC may transmit the read KEK and log data corresponding thereto to the key verifier (operation S13). The key verifier may generate a hash value for the KEK received from the SoC (operation S14). The key verifier may verify the KEK by comparing the generated hash value with the log data (operation S15).

Meanwhile, the key encryption key according to an embodiment of the present disclosure may be used for secure booting of the SoC.

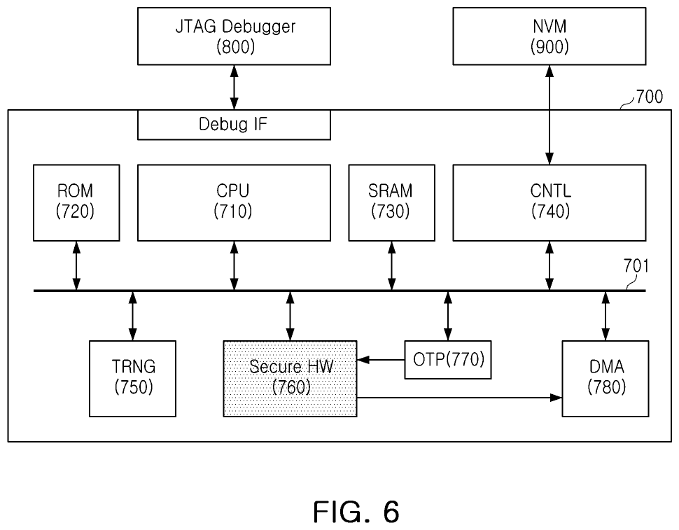

FIG. 6 is a diagram illustrating an system on chip (SoC) 700 according to an embodiment of the present disclosure. Referring to FIG. 6, the SoC 700 may include a CPU 710, a ROM 720, an SRAM 730, a controller (CTRL) 740, a random number generator (TRNG) 750, security hardware 760, an OTP memory 770, and a DMA 780. The SoC 700 may be connected to a JTAG debugger 800 by a debug interface.

The CPU 710 may be a central processing unit configured to control the entire SoC 700 and to execute a program. A boot program code inside the ROM 720 may be recorded during a manufacturing process of the SoC 700, and may not be modified thereafter. The SRAM 730 may be a memory configured to temporarily store output data or temporarily store data required by the CPU 710.

A nonvolatile memory device 900 may be a memory in which a signature key is stored together with a program code during the manufacturing process of the SoC 700. The boot program code may record information about the location where the signature key is stored in the nonvolatile memory device 900. The nonvolatile memory device 900 may be connected to the SoC 700 from the outside. When the SoC 700 is manufactured, hash data may be generated from the program code by a hash algorithm. This hash data may be encrypted by a key encryption key (e.g., KEK of FIG. 3) to generate the signature key. As such, since both the program code and the signature key generated therefrom are stored in the nonvolatile memory device 900, there is double protection for the program code. As a result, a portion of the program code required by the CPU may be read and stored in a cache memory in advance among the entire program code, and then the CPU may read the program code in the cache memory, so that the CPU's operating speed may be compensated for in order that it does not slow down.

The security hardware 760 may be hardware configured to control booting by the CPU 710 only when the program code is verified as not being tampered with during secure booting. The security hardware 760 may be a block where a security algorithm is driven, and may be implemented as hardware within the SoC 700.

In addition, the security hardware 760 may be characterized by including a hash algorithm processing block and a signature verification processing block as sub-blocks within it. That is, an operation of checking whether the program code is distorted or tampered with for secure booting may be doubly configured. The hash algorithm processing block may be a block that generates current hash data from the program code stored in the nonvolatile memory device 900 using the hash algorithm in an SoC internal security engine. The hash data may be data that is uniquely determined by matching with the program code. The hash algorithm processing block may be a hardware block inside the security engine configured to process the hash algorithm such as SHA1, SHA-256, SHA-384 and the like, and may have an algorithm that converts and generates specific and unique hash data from an original program code. When the program code is passed through the hash algorithm of SHA-256, the unique data may be output. The signature verification processing block may be a block that decrypts the signature key stored in the non-volatile memory device 900 using a decryption key and generates a decrypted signature key. The signature verification processing block may verify that the program code has not been tampered with if the current hash data and the decrypted signature key are the same. In other words, it is an operation for verifying whether the signature key stored in a flash memory together with or included in the program code is valid. The decryption location may be inside the signature verification processing block.

The signature verification processing block may be is a block that processes an algorithm mainly used for key authentication, such as Rivest Shamir Adleman (RSA) and Elliptic Curve Cryptosystem (ECC), may receive data encrypted with a public key and use the private key of the signature verification processing block to decrypt the encrypted data. The decrypted signature key may eventually become the hash data. Therefore, the hash data generated by the hash algorithm processing block and the decrypted signature key generated by the signature verification processing block may be compared to see if they are the same. If they are the same, which means that a secure boot passes, it may proceed to the next operation, that is, a boot process by the CPU. If they are not the same, which means that the secure boot fails, it may stop operating at that state. In other words, it may be checked whether an application software has been tampered with, and only when the application software is determined to be untampered application software (a program code), the SoC (CPU) may boot.

Among the application programs running on the SoC, some may require a secure boot, while others may not. Therefore, a single SoC may be used to support all types of applications by providing an SoC applicable to both of these two types of application programs. To this end, in the present disclosure, it may be desirable to design the SoC to support both a secure boot mode and a general boot mode, and to allow one of them to be selected and designated during an SoC manufacturing stage. Here, an OTP memory storing a value that designates the secure boot mode or the general boot mode may be further provided within the SoC. Programming for the OTP memory may be performed during the SoC manufacturing stage, and due to its nature, only a single writing thereon may be possible. A value of “1” written to the OTP memory may be designated to the secure boot mode, while a value of “0” may be designated to the general boot mode.

The OTP memory 770 may store the key encryption key (e.g., KEK of FIG. 3) described in FIGS. 1 to 5 and boot mode information indicating the boot mode. During a ROM boot process, the boot mode information of the OTP memory 770 may be read by the boot code. That is, a boot sequence may be changed according to a value of the boot mode information. If the value of the boot mode information is the value of the general boot mode, a secure boot related circuit, i.e., the security hardware 760, may not operate. Therefore, booting by the CPU 710 may continue without determining whether the program code and the data are distorted. Conversely, if the value of the boot mode information is the value of the secure boot mode, the circuit related to the secure boot, i.e., the security hardware 760 within the SoC, may operate. Accordingly, it is possible to determine whether the program code and the data (signature key) stored in the nonvolatile memory device are distorted, and if there is any distortion, the booting may stop. A security key block may be a place where a key value to be used in the security engine is stored, and include a platform key, a device unique key, a device ID, etc.

A person of skill in the art would understand that embodiments of the present disclosure may be applied to a processor.

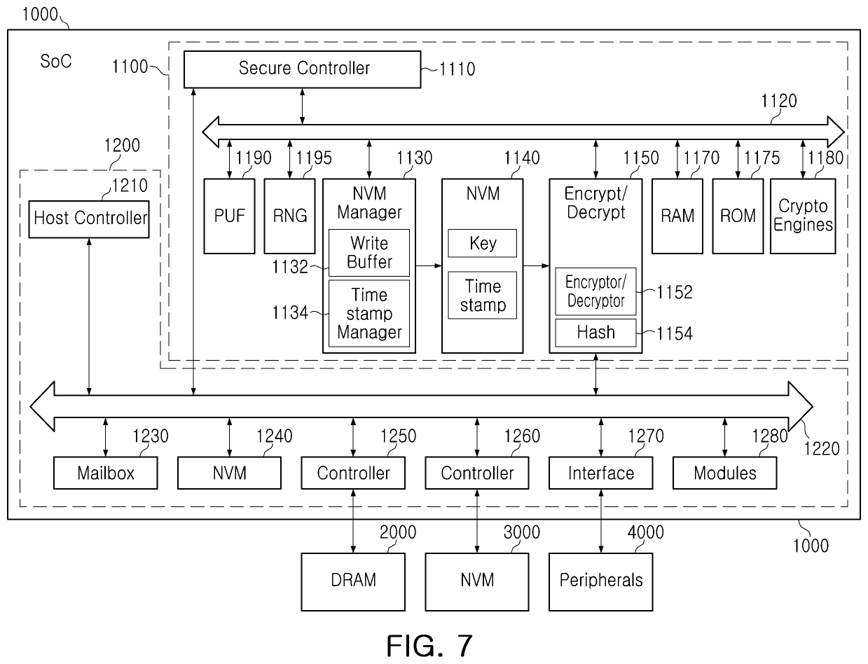

FIG. 7 is a diagram exemplarily illustrating a processor 1000 according to an embodiment of the present disclosure. Referring to FIG. 7, the processor 1000 may include a security module 1100 and a normal module 1200.

The security module 1100 may include a security controller 1110, a first memory manager 1130, a first memory 1140, an encryptor/decryptor 1150, a RAM 1170, a ROM 1175, a crypto engine 1180, a physical unclonable function (PUF) 1190, and a random number generator 1195. The security controller 1110, the first memory manager 1130, the encryptor/decryptor 1150, the RAM 1170, the ROM 1175, the crypto engine 1180, the PUF 1190 and the random number generator 1195 may be connected to each other via a first bus 1120.

The security controller 1110 may be connected to the first bus 1120 and control an operation of the security module 1100. The security controller 1110 may provide an isolated execution environment independently performing security operations without interference from the normal module 1200. For example, the security controller 1110 may generate a key encryption key and its log data, and store the key encryption key and the log data, as described in FIGS. 1 to 5.

The first memory manager 1130 may include a write buffer 1132 and a time stamp manager 1134. The write buffer 1132 may store data according to a write command of the security controller 1110. The time stamp manager 1134 may control a time stamp stored in the first memory 1140.

The PUF 1190 and the random number generator 1195 may generate a security parameter. The PUF 1190 or the random number generator 1195 may generate the security parameter (or random data or a key encryption key) and inject it into the first memory 1140.

The first memory 1140 may include the security parameter. The security parameter may include an encryption key (Key) and a time stamp. The first memory 1140 may not be connected to the first bus 1120, but may be connected to the first memory manager 1130. The first memory 1140 may not be accessed by the security controller 1110, and may be accessed by the first memory manager 1130. That is, the security controller 1110 may not read or write data stored in the first memory 1140. Therefore, even if the security controller 1110 is hacked, the security controller 1110 may not access the first memory 1140, so that the security parameters may be safely stored and a security level of the normal module 1200 may be increased. In an embodiment, the first memory 1140 may include a nonvolatile memory (NVM). For example, the NVM may be an OTP memory.

The encryptor/decryptor 1150 may include an encryption/decryption unit 1152 and a hash unit 1154. The encryption/decryption unit 1152 may perform an encryption operation on security data transmitted from the security processor (1110) using the security parameter according to an encryption algorithm. The encryption/decryption unit 1152 may perform a decryption operation on encrypted data transmitted from an external memory device 2000 and 3000. The encryption algorithm may be AES (advanced encryption standard), DES (1data encryption standard), Triple DES, SEED, HIGHT (HIGH security and light weigHT), ARIA, Lightweight Encryption Algorithm (LEA), etc. In addition, for example, the encryption algorithm may perform an encryption operation in a block cipher mode. The block cipher mode may be an electronic code book (ECB) mode, a cipher block chaining (CBC) mode, a CTR mode, a propagating cipher block chaining (PCBC) mode, a cipher feedback (CFB) mode or the like.

The hash unit 1154 may calculate a message authentication code (MAC) using the security parameter. The hash unit 1154 may calculate the message authentication code using a hash-based message authentication code (HMAC) algorithm, a cipher-based message authentication Code (CMAC) algorithm or the like. In addition, the hash unit 1154 may calculate a hash value for a key encryption key generated from the PUF or the random number generator to generate log data of the key encryption key.

The encryptor/decryptor unit 1150 may output the encrypted data including the encrypted security data and the message authentication code. The encrypted data, such as security data or security code, may be temporarily stored in the RAM 1170. The RAM 1170 may receive an encryption code on the fly from a first external memory device 2000. The security data, the security code or the encryption code stored in RAM 1170 may be executed by the security controller 1110.

The ROM 1175 may non-volatilely store the security data or the security code. The ROM 1175 may store data required for the security module 1100 to perform a security operation. The security data or the security code stored in the ROM 1175 may be executed by the security controller 1110. The crypto engine 1180 may be connected to the first bus 1120. The crypto engine 1180 may encrypt data stored in the memories 1170 and 1175 within the security module 1100.

The normal module 1200 may include a host controller 1210, a mailbox 1230, a shared memory 1240, a first external memory controller 1250, a second external memory controller 1260, an interface 1270 and various modules 1280. The host controller 1210, the mailbox 1230, the shared memory 1240, the first external memory controller 1250, the second external memory controller 1260, the interface 1270 and the modules 1280 may be connected to each other through a second bus 1220. The first bus 1120 and the second bus 1220 may provide a data input/output path or a command path, etc. The host controller 1210 may be connected to the second bus 1220 to control an operation of the normal module 1200. The host controller 1210 may communicate with the security controller 1110 through the mailbox 1230.

The shared memory 1240 may store data required for an operation of the host controller 1210. The host controller 1210 and the security controller 1110 may communicate through the shared memory 1240. The shared memory 1240 may include, for example, a non-volatile memory (NVM).

The processor 1000 may be connected to the first external memory device 2000 and the second external memory device 3000 externally placed due to a limited storage area or the like of the processor 1000. The first external controller 1250 and the second external controller 1260 may provide the encrypted data provided from the security module 1100 to the first external memory device 2000 or the second external memory device 3000. The first external controller 1250 and the second external controller 1260 may provide the encrypted data or the encrypted code stored in the first external memory device 2000 or the second external memory device 3000 to the security module 1100. The normal module 1200 may include the various modules 1280 for driving the processor 1000. A peripheral electronic device 4000 may be connected to the processor 1000 through the interface 1270. The peripheral electronic device 4000 may include, for example, a display and an image sensor that communicate with the processor 1000.

The devices described above may be implemented as hardware components, software components and/or a combination of hardware components and software components. For example, the devices and components described in the embodiments may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor or any other device capable of executing instructions and responding to them. The processing device may execute an operating system (OS) and one or more software applications running on the operating system. In addition, the processing device may access, store, manipulate, process and generate data in response to an execution of software. For ease of understanding, the processing device may be sometimes described as being used alone, but it will be appreciate by those skilled in the art that the processing device may include multiple processing elements or multiple types of processing elements. For example, the processing device may include multiple processors, or one processor and one controller. In addition, other processing configurations, such as parallel processors, may be possible.

The software may include a computer program, codes, instructions or a combination thereof, and may configure the processing device to operate as desired or may independently or collectively command the processing device. The software and/or data may be embodied in any type of machine, component, physical device, virtual equipment, computer storage medium or device for interpretation by the processing device or for providing instructions or data to the processing device. The software may be distributed over networked computer systems and stored or executed in a distributed manner. The software and data may be stored on one or more computer-readable recording media.

The integrated circuit and its operating method according to an embodiment of the present disclosure may increase a level of security by generating a key encryption key internally in the chip and storing the generated key encryption key in a nonvolatile memory, such as an OTP memory. An integrated circuit and an operating method thereof according to an embodiment of the present disclosure may enable verification of a key encryption key by storing a key encryption key and a hash value of the key encryption key in non-volatile memory.

Furthermore, while example embodiments have been shown and described above, it will be apparent to those skilled in the art that modifications and variations could be made without departing from the scope of the present disclosure as defined by the appended claims.

What is claimed is:

1. A method of operating an integrated circuit, the method being executed by at least one processor, the method comprising:
generating a key encryption key (KEK) using a random number generator;
generating log data corresponding to the KEK using a log generator; and
storing the KEK and the log data in a one-time programmable (OTP) memory,
wherein the KEK is used to encrypt a master key of the integrated circuit for a cryptographic operation, and
wherein the random number generator and the log generator are comprised in the integrated circuit.

2. The method of claim 1, wherein the random number generator comprises a true random number generator.

3. The method of claim 1, wherein the log generator comprises a hash logic.

4. The method of claim 3, wherein the generating the log data comprises:
calculating a hash value for the KEK using the hash logic,
wherein the hash value is the log data.

5. The method of claim 1, wherein the storing the KEK and the log data in the OTP memory comprises:
fusing an e-fuse to store the KEK and the log data in the OTP memory.

6. The method of claim 1, further comprising:
receiving a key verification request from an external device.

7. The method of claim 6, further comprising:
reading the KEK and the log data from the OTP memory in response to the key verification request; and
outputting the KEK and the log data, read from the OTP memory, to the external device.

8. The method of claim 6, further comprising:
performing an authentication operation with the external device prior to the receiving the key verification request.

9. The method of claim 1, further comprising:
encrypting an encryption key or data using the KEK.

10. The method of claim 1, wherein the integrated circuit comprises an OTP controller configured to control the OTP memory, and
the OTP controller is configured to fuse the KEK and the log data to the OTP memory without software intervention from an external device.

11. An integrated circuit, comprising:
a one-time programmable (OTP) memory;
a random number generator configured to generate random data corresponding to a key encryption key (KEK);
a key manager configured to generate log data for the KEK; and
an OTP controller configured to fuse the KEK and the log data to the OTP memory,
wherein the KEK is used to encrypt a master key of the integrated circuit for a cryptographic operation.

12. The integrated circuit of claim 11, wherein the key manager is implemented in software, hardware, or firmware.

13. The integrated circuit of claim 11, wherein the key manager comprises a log generator configured to generate the log data.

14. The integrated circuit of claim 13, wherein the log generator comprises a hash logic configured to receive the KEK and generate a hash value of the KEK.

15. The integrated circuit of claim 11, wherein the OTP controller is further configured to read the KEK and the log data from the OTP memory in response to a key verification request from an external device, and output the key encryption key and the log data, read from the OTP memory, to the external device.

16. A method of operating an integrated circuit, the method being executed by at least one processor, the method comprising:
receiving a key verification request from an external key verifier;
reading a KEK and log data corresponding to the KEK from a one-time programmable (OTP) memory in response to the key verification request; and
outputting the KEK and the log data to the external key verifier,
wherein the KEK is used to encrypt a master key of the integrated circuit for a cryptographic operation.

17. The method of claim 16, further comprising:
performing an authentication operation with the external key verifier before receiving the key verification request from the external key verifier.

18. The method of claim 16, wherein the integrated circuit comprises an OTP controller configured to control the OTP memory, and
the OTP controller is further configured to fuse the KEK and the log data to the OTP memory without software intervention from an external device.

19. The method of claim 18, wherein the integrated circuit further comprises a key manager configured to calculate a hash value of the KEK to generate the log data.

20. The method of claim 18, wherein the integrated circuit further comprises a random number generator or a physically unclonable circuit, the random number generator or the physically unclonable circuit are configured to generate the KEK.
